(19) United States
(12) Patent Application Publication
(10) Pub. No.: US 2006/0274987 A1
(43) Pub. Date: Dec. 7, 2006

(54) HIGH SPEED REPROGRAMMABLE ELECTRO-OPTICAL SWITCHING DEVICE

(76) Inventors: Madeleine Mony, Montreal (CA); David V. Plant, Westmount (CA); Eric Bisaillon, Montreal (CA); Julien Faucher, Montreal (CA)

Correspondence Address: GOUDREAU GAGE DUBUC, 800 PLACE VICTORIA, SUITE 3400, MONTREAL, QUEBEC, H4Z 1E9, CA

(21) Appl. No.: 11/422,020

(22) Filed: Jun. 2, 2006

Related U.S. Application Data
(60) Provisional application No. 60/686,910, filed on Jun. 3, 2005.

(51) Int. Cl. G02F 1/295

(52) U.S. Cl. 385/4

(57) ABSTRACT

An electro-optic switching device, namely an optical phased array (OPA) or a reprogrammable optical phased array (ROPA), that can accommodate high switching speeds, reduced losses and increased efficiency while being adapted to operate at various wavelengths using suitably low activation voltages is presented. The ROPA designs presented herein are generally comprised of an electro-optic (EO) crystal electrically mounted to a high-voltage CMOS chip activated to apply an array of activation voltages across the crystal and induce a refractive index profile therein, such profile adaptable to selectively control and manipulate an optical beam interacting with the device.

### CROSS REFERENCE TO RELATED APPLICATIONS

This application claims priority on U.S. provisional application No. 60/686,910 filed on Jun. 3, 2005 the entirety of which is incorporated herein by reference.

### FIELD OF THE INVENTION

The present invention relates a high speed reprogrammable electro-optical switching device. More specifically, the present invention is concerned with a electro-optic high speed reprogrammable diffractive optical element having applications comprising, for example, switches in all-photonic networks, variable focus length lenses and general beam shaping mechanisms.

### BACKGROUND OF THE INVENTION

Over the past decade, there has been an evolution in the design of optical networks to match the changing needs of internet carriers. Networks are now designed not only to increase the available bandwidth, but also to decrease the overall cost and to increase the flexibility of the network. One way to achieve these goals is to migrate from an electrically switched Optical-Electronic-Optical (OEO) fabric to an optical switch fabric which will reduce cost, latency and power consumption, while rendering the switch data rate and protocol independent. By introducing the requirement for very fast optical switching in the core, dynamic provisioning and packet level switching become possible.

Currently deployed optical switching technologies are too slow for such dynamic provisioning (e.g. Micro Electro-Mechanical Systems (MEMS), thermo-optic switches). In contrast, electro-optic (EO) switching holds great promise due to its high-speed and lack of moving parts. Yet, prior art electro-optic switch designs, such as waveguide and bulk electro-optic switches, have significant drawbacks: in the waveguide structure the coupling losses tend to be high and in the bulk structure the required voltages approach 1 kV.

One particular type of EO switch that shows promise consists of optical phased arrays (OPAs). The main concept behind OPA designs involves the application of multiple electric fields of different magnitudes across an EO material in order to create a diffractive optical element (DOE). Prior art OPAs reported in scientific literature attempt to address current issues in optical switching, but have yet to provide a suitably fast and low-loss design for commercial use in, for example, optical communication networks and the like.

A first prior art OPA design reported in the scientific literature involves depositing a set of alternating linear high voltage and ground electrodes on a front face of an EO material thereby generating an electric field between the electrodes that varies the index of refraction of the material therebetween. A beam of light incident on this front face can thus be steered through the crystal by adjusting the electrode voltages. A first disadvantage of this design resides in the electrodes blocking some of the light, and thus reducing the efficiency of the OPA. Also, electrode deposition and activation methods used for these designs are generally only suitable to create coarse grating configurations defined by a limited number of relatively large electrodes.

A second prior art OPA design uses liquid crystals as EO material. One such design applies a set of linear high voltage electrodes on a front face of the liquid crystal device and a large ground electrode on a back face thereof, wherein a beam incident on the front face is reflected on the back face and steered by a voltage applied to the electrodes that controls the index of refraction of the liquid crystal. This design is generally quite slow (order of 1 ms) and thus not useful in most contexts, as are other known liquid crystal designs.

A third prior art OPA design involves applying the above electrode configuration on an EO material, namely LiTaO₃ or LiNbO₃ and directing light in a direction parallel to the electrodes through a thickness of the material. Again, unsuitably high voltages are required in these designs and, as in the first prior art OPA design presented hereinabove, the electrode deposition and activation methods used in these designs are again generally only suitable to create coarse grating configurations defined by a limited number of relatively large electrodes.

Finally, a fourth prior art OPA design propagates light through waveguides built within the EO material, namely AlGaAs or GaAs/AlGaAs. The design includes a linear high voltage electrode on a front face of the OPA atop each waveguide and a ground electrode on a back face of the OPA opposite the front face. Light propagating in the waveguides is steered by an array of voltages applied between the electrodes. The main drawback of this design, as well as for all waveguide-based designs, consists of coupling the light in and out of the waveguides, which generally generates unsuitable losses and great reductions in efficiency.

It is also important to note that none of the above designs provide 2D beam steering solutions, each being limited to the formation of 1D linear voltage arrays designed to induce coarse 1D gratings and beam steering options.

Consequently, an electro-optic switching device, namely an OPA, that can accommodate the high switching speeds required by emerging optical network demands, reduce losses and thus increase efficiency while being adapted to operate at various wavelengths using suitably low activation voltages is needed. The present invention, as described herein, seeks to meet these needs and other needs as well as overcome the above and other drawbacks of prior art EO switch designs.

### SUMMARY OF THE INVENTION

In order to address the above and other drawbacks there is provided an optical device comprising an electro-optic crystal comprising a first surface and a second surface opposite the first surface, a plurality of first regions between the first surface and the second surface, and a means for applying a voltage across each of the regions, each of the applied voltages inducing a change in the refractive index of a respective one of the regions. A light beam entering the crystal along a first path exits the crystal along a second path at an angle to the first path.

There is also disclosed a method for defracting a beam of light travelling along a path, the method comprising the steps of: providing an electro-optic crystal comprising a first surface and a second surface opposite the first surface, defining a plurality of regions between the first surface and the second surface along the path, and applying a voltage across each of the regions, each of the applied voltages inducing a change in the refractive index of a respective one of the defined regions.

Additionally, there is disclosed an electro-optic crystal for use as an active medium in an optical switch, the optical switch adapted to reflectively redirect an optical beam incident thereon from a first reflected direction to at least one second reflected direction when a spatially periodic voltage gradient is applied between opposing faces of the crystal, a maximum voltage applied to the crystal to generate the voltage gradient being below about 300V, the crystal being defined by an electro-optic tensor comprising at least one coefficient sufficiently large to induce at least a 2π phase shift in an optical beam travelling through the crystal in a region thereof where the maximum voltage is applied.

Other aims, objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIGS. 1A and 1B are perspective and side views respectively of a 2D reflection mode ROPA in accordance with a first illustrative embodiment of the present invention;

FIGS. 2A and 2B are perspective and side views respectively of a 1D reflection mode ROPA in accordance with a second illustrative embodiment of the present invention;

FIGS. 3A and 3B are perspective and side views respectively of a 1D transmission mode ROPA in accordance with a third illustrative embodiment of the present invention;

FIG. 4 is a plot of simulated refraction grating efficiencies as a function of grating height for 4-level gratings having uneven and even step distributions;

FIG. 5 is a plot of simulated refraction grating efficiencies as a function of intra-level gap sizes for 4-level gratings having a 52 μm period.

FIG. 6 is a plot of the index ellipsoid for BaTiO₃ in the xz plane in the presence of an electric field Eₓ=0 and Eₓ>>1 a BaTiO₃ crystal being a suitable choice for an implementation of the ROPAs of FIGS. 1A and 2A;

FIGS. 7A and 7B are perspective diagrams of possible crystal and beam geometries suitable for the implementation of the ROPAs of FIGS. 1A and 2A when using the crystal and electric field configurations of FIG. 6;

FIGS. 8A and 8B are plots of changes in an index of refraction of a BaTiO₃ crystal under various voltages experienced by an optical beam tuned at 1310 nm travelling at various angles relative to the x-axis of the crystal in accordance with the crystal and beam geometry of FIG. 7B; FIG. 8A further identifies the index change required to induce a 2π phase shift in the beam as it travels trough a 500 μm thick crystal in transmission mode whereas FIG. 8B identifies the index change required to induce a 2π phase shift in the beam as it travels trough a 500 μm thick crystal in reflection mode;

FIGS. 9A and 9B are perspective and side views respectively of an optical switch operating in reflection mode in accordance with a fourth illustrative embodiment of the present invention; and

FIG. 10 is a bar diagram of a diffraction efficiency of the optical switch of FIGS. 9A and 9B as a function of the number of electrodes within one period of a diffraction grating generated within the optical switch.

### DETAILED DESCRIPTION OF THE ILLUSTRATIVE EMBODIMENTS

As stated hereinabove, electro-optic switching holds great promise for use in optical networks due to its high-speed and lack of moving parts. However, prior art electro-optic switching devices are plagued by two drawbacks: in waveguide-based switches the coupling losses are generally quite high, whereas bulk electro-optic switch designs require high operating voltages ranging around 1 kV, voltages inappropriately high for their intended use.

The illustrative embodiments of the present invention provide an electro-optical switch that is ideal for all-photonic networks in that it is fast, exhibits low loss and is tunable to a wide range of wavelengths. The novel electro-optical switch designs presented herein, manufactured using various materials and technologies which are new to the art of optical switch design, are both fast (switching times ranging from nanoseconds to tens of microseconds versus millisecond responses for liquid crystal switches) and can be used with voltages below about 300V, considerable improvements over prior art designs. Furthermore, these switch designs are constructed without moving parts (MEMS), are small in size and can be electrically reprogrammed to handle different wavelengths.

As will be discussed in detail hereinbelow, the designs take advantage of applying multiple electric fields of different magnitudes across an electro-optic (EO) crystal in order to create a diffractive optical element (DOE). Both the profile and the periodicity of the device can be reconfigured by changing the voltages on the electrodes thereof. These devices may be classified as Optical Phased Arrays (OPAs) or in the illustrative embodiments disclosed herein, as Reprogrammable Diffractive Optical Elements (RDOEs) or Reprogrammable Optical Phased Arrays (ROPAs). For clarity, the following discussion will limit itself to the use of the term ROPA to identify these devices.

It is important to note at this point that although this disclosure will discuss primarily the use of ROPAs as optical switching and beam steering devices, a person of skill in the art will understand that such devices may also be considered for various other applications including, but not limited to, variable focus length lenses, multiple spot generation, corrections to free-space misalignments, beam shaping, and the like. Namely, as will be presented below, a ROPA may be used to controllably modify the properties of an output beam generated thereby from an input beam incident thereon. Ultimately, a ROPA may be programmed and used to selectively control the properties of a beam optically interacting therewith.

Advantages of using a ROPA for such applications include, but are again not limited to, the speed of electro-optic materials ranging in general on the order of 1 ns, the absence of mechanical motion, their relatively small size and the ability to electrically reprogram the ROPA to handle different wavelengths.

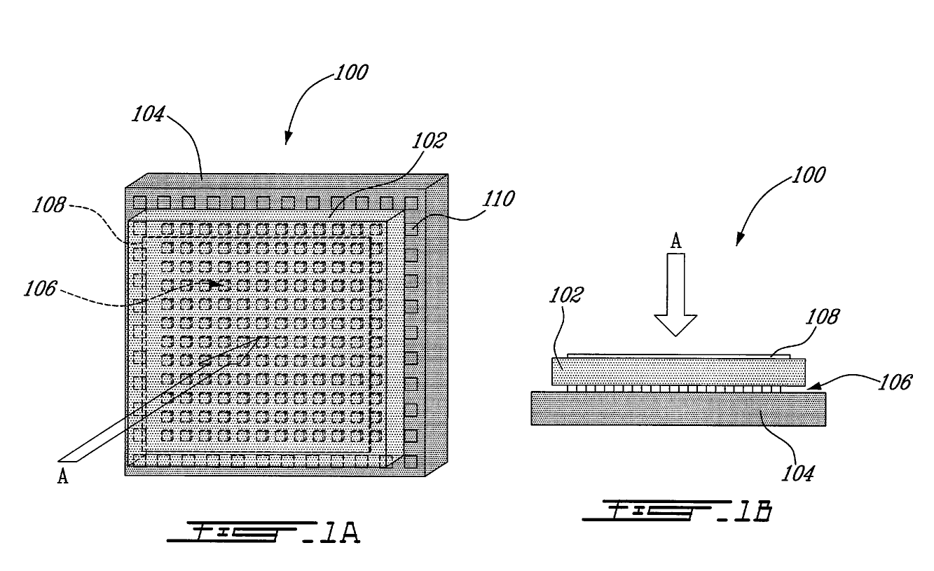

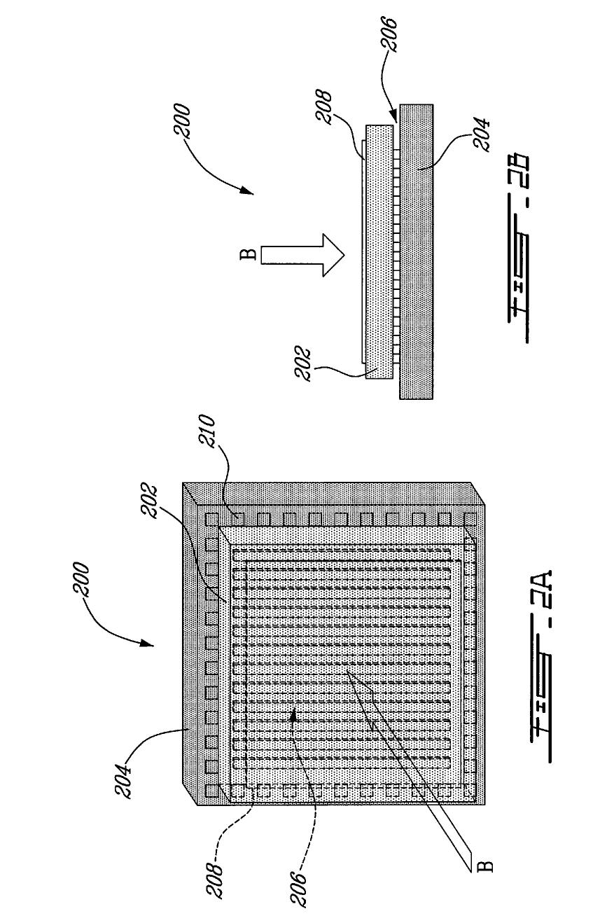

Referring now to FIGS. 1A and 1B, a 2D reflection mode ROPA, generally referred to using the numeral 100 and in accordance with a first illustrative embodiment of the present invention, will now be described. The ROPA 100 is generally comprised of an EO crystal 102 electrically mounted to a CMOS chip 104. An array of reflective contact electrodes, as in 106, are disposed between a front face of the CMOS chip 104 and the back face of the EO crystal 102. An additional ground contact electrode 108, illustrated here as a substantially transparent Indium Tin Oxide (ITO) electrode, is mounted on a front face of the crystal and adequately grounded such that an array of activation voltages may be applied through the crystal 102 by the CMOS chip 104 between the reflective electrodes 106 and ground electrode 108. Possible methods to ground the electrode 108 include, but are not limited to, wirebonding, gluing a wire with conductive epoxy, and other such methods. An anti-reflection coating may also be deposited on the ITO electrode 108 to reduce undesired reflections off the crystals front face.

The CMOS chip 104 is made from a high-voltage CMOS process capable of both low-voltage and high-voltage digital design. A CMOS chip, such as the DALSA Semiconductor C08G process providing 5V logic for a maximum 300V process, provides high activation voltages with a sufficiently high resolution to implement the desired voltage patterns in the selected crystal 102. For instance, such CMOS chips have been tested to provide 64 voltages, to be applied to the array of electrodes 106, ranging from 0 to 300V with a 4.7V resolution. Furthermore, tested electronic switching times are less than 8.7 μs.

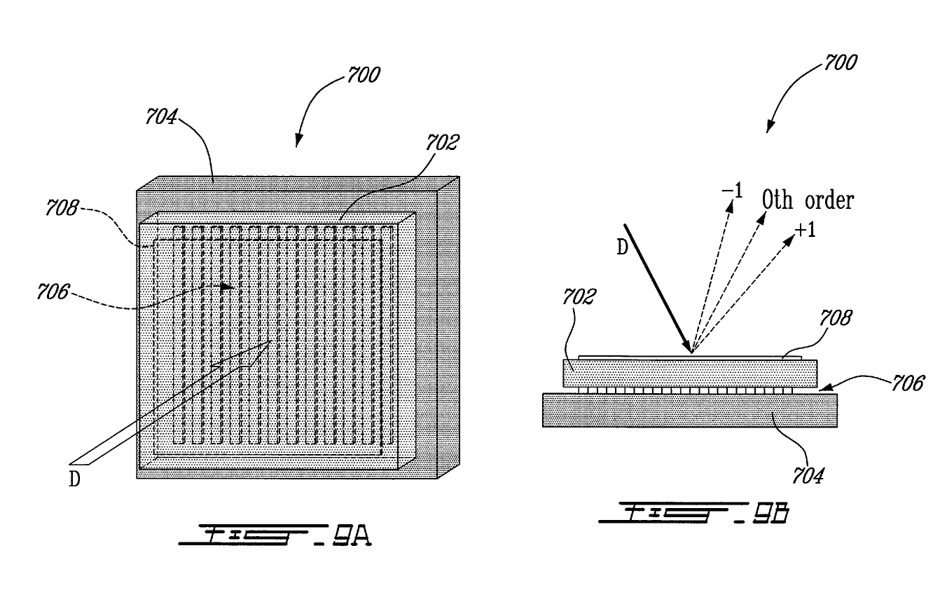

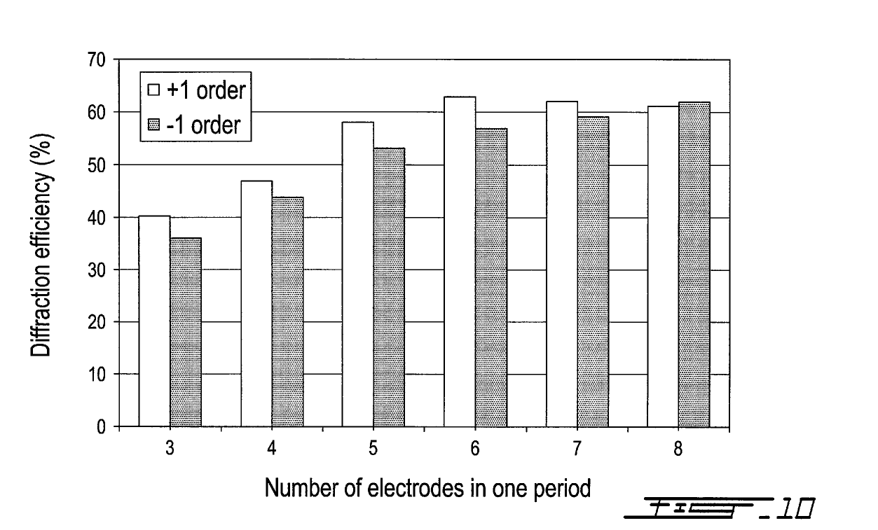

As will be discussed further hereinbelow, selection of a suitable EO crystal 102 for use in ROPA 100 will be at least partially guided by the general limitations and characteristics of the CMOS chip 104, namely in its maximum available voltage of about 300V. The ROPA 100 should be designed, and thus the crystal 102 selected, to operate below this maximum voltage. For instance, when the ROPA 100 is used as a diffracting optical switch, as discussed further hereinbelow with reference to FIGS. 9A and 9B, the ROPA 100, operating with voltages below the chip maximum, should be able to generate at least a 2π phase shift in an input optical beam travelling through the ROPA and experiencing these voltages.

A person of skill in the art will understand that although the present discussion refers to the use of a CMOS chip, as in 104, other types of integrated circuit structures or electronic activation devices may be considered without extending the scope and nature of the present disclosure. Consequently, any electronic device and electrode configuration capable of generating a compact organized array of activation voltages across an EO crystal such that a beam interacting with the crystal may be rapidly and efficiently manipulated or redirected therein, can be considered in the above and following discussion to replace or complement the described CMOS chips.

To control the CMOS chip and consequently control the ROPA 100 through the application of the above-mentioned voltages, the chip 104 is equipped with an appropriate set of wirebond pads, as in 110, such that the chip 104 may be mounted to a circuit board or the like (not shown) of a computer, a field programmable gate array (FPGA), or other such configurable electronic devices (not shown). As described hereinbelow, by programming the activation of these voltages, the ROPA 100 may be used to manipulate an optical beam incident thereon and reflected thereby.

The crystal 102 is illustratively mounted to the CMOS chip 104 using a flip-chip method thereby providing that all contacts between the reflective electrodes 106 and the crystal 102 are completed simultaneously and evenly. However, other crystal mounting methods may also be considered without departing from the general scope and nature of the present disclosure. In this illustrative embodiment, the crystal contacts are first constructed using various metallic layers. On the back face of the crystal 102 (between the crystal 102 and the chip 104), a first layer of aluminium is deposited for each contact; aluminium is selected in this case for its reflective properties as optical beams interacting with the ROPA 100 will be reflected on these reflective electrodes 106 to be controllably redirected by the ROPA 100. Following the aluminium layer, a titanium and a gold layer are consecutively deposited to complete the crystal electrodes, the titanium layer being used as an intermediate layer between the relatively incompatible gold and aluminium layers.

On the CMOS chip 104, an array of gold chip contacts are positioned to correspond to the array of crystal contacts and are each independently controlled by the chip 104 to apply the necessary voltages to the electrodes 106. To connect the crystal contacts to the gold contacts of the CMOS chip 104, indium/tin beads or lumps are first positioned on each of the gold contacts. The crystal 102 is then flipped and the crystal and chip contacts aligned. Finally, the beads are heated and the crystal 102 and chip 104 squeezed together to complete the bond between the respective contact layers. Once this step is complete and the ground electrode is adequately grounded, the ROPA 100 is ready to be used.

As presented hereinabove, by applying multiple voltages of different magnitudes across the crystal 102, corresponding electric fields will be generated in the crystal that will induce patterned changes in the index of refraction of the crystal 102, thereby creating a diffractive optical element. Both the profile and the periodicity of the device can be reconfigured by changing the voltages on the electrodes 106.

In the absence of applied voltages, an optical beam A incident on the ROPA 100 will be reflected thereby in a direction governed by simple geometrical optics. On the other, if an array of voltages are applied to the crystal 102, namely generating a periodic 1D or 2D refractive index change in the crystal 102, the optical beam A will be redirected by the ROPA 100 in a direction determined by the profile and periodicity of the refractive index change. A person of skill in the art will thus understand that by controllably varying the applied voltages, the beam A will be controllably redirected by the ROPA 100, namely alternatively coupling reflected beams generated thereby in various optical channels of a communication network. Furthermore, due to the rapid response of the EO crystal 102 to changing voltages, as opposed to liquid crystals for example, changes in beam redirection and control can be implemented rapidly.

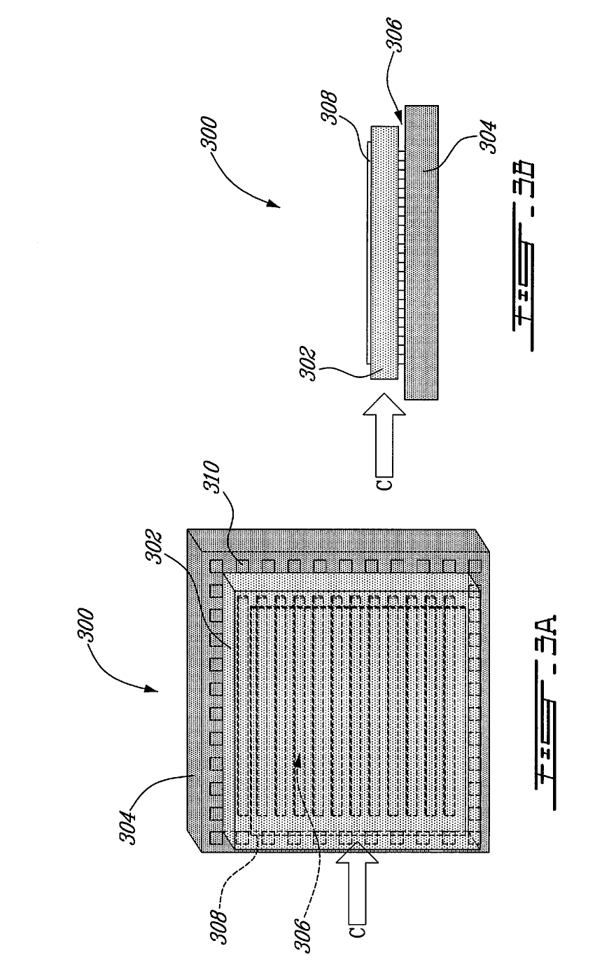

Referring now to FIGS. 2A and 2B, a simplified reflection mode ROPA, generally referred to using the numeral 200 and in accordance with a second illustrative embodiment of the present invention, will now be described. ROPA 200 is constructed much like the ROPA 100 in that it is comprised of an EO crystal 202 electrically coupled to a CMOS chip 204. A 1D array of reflective contact electrodes, as in 206, are illustratively deposited on the EO crystal 202 between a front face of the CMOS chip 204 and a back face of the EO crystal 202. An additional ground contact electrode 208, again illustratively a substantially transparent Indium Tin Oxide (ITO) electrode, is deposited on the front face of the crystal 202 and adequately grounded such that a linear array of activation voltages may be applied through the crystal 202 by the CMOS chip 204 between the reflective electrodes 206 and the ground electrode 208. To activate such voltages and control the ROPA 200, the chip 204 may again be mounted to a circuit board or the like activated and controlled by a computer, a field programmable gate array (FPGA), or other such configurable electronic devices (not shown). A flip-chipping method is again used to mount the crystal 202 to the chip 204.

The main difference between ROPA 200 and ROPA 100 lies in their ability to control the redirection of an incident beam in one (1) and two (2) dimension(s) respectively. Also, the design of ROPA 200 reduces the number of independent voltages required and allows for a tighter spacing of the electrodes since logic controlling each one can be placed on the periphery of the chip 204. Otherwise, the general construction, function and activation of the respective ROPAs 200 and 100 is practically the same. Namely, voltages of varying magnitudes are applied by the CMOS chip 204 to the reflective electrodes 206 thereby generating corresponding electric fields in the crystal 202 that induce local changes in the index of refraction of the crystal 202. Since the electrodes are generally rectangular and disposed linearly in a 1D array, the application of periodically varying voltages across the crystal has for effect the generation of a controllable 1D grating that can be used to control the redirection of a beam B reflected on the ROPA 200.

Again, the CMOS chip 204 is made from a high-voltage CMOS process capable of both low-voltage and high-voltage digital design, such as the DALSA Semiconductor C08G process discussed hereinabove with reference to the ROPA 100. The ROPA 200 should also be designed, and thus the crystal 202 selected, to operate using voltages below the maximum voltage of the CMOS process (about 300V), while providing the capability of generating at least a 2π phase shift in an input optical beam B travelling through the ROPA 200 and experiencing these voltages. CMOS control methods and flip-chip methods, as discussed hereinabove, may also apply to the design of ROPA 200.

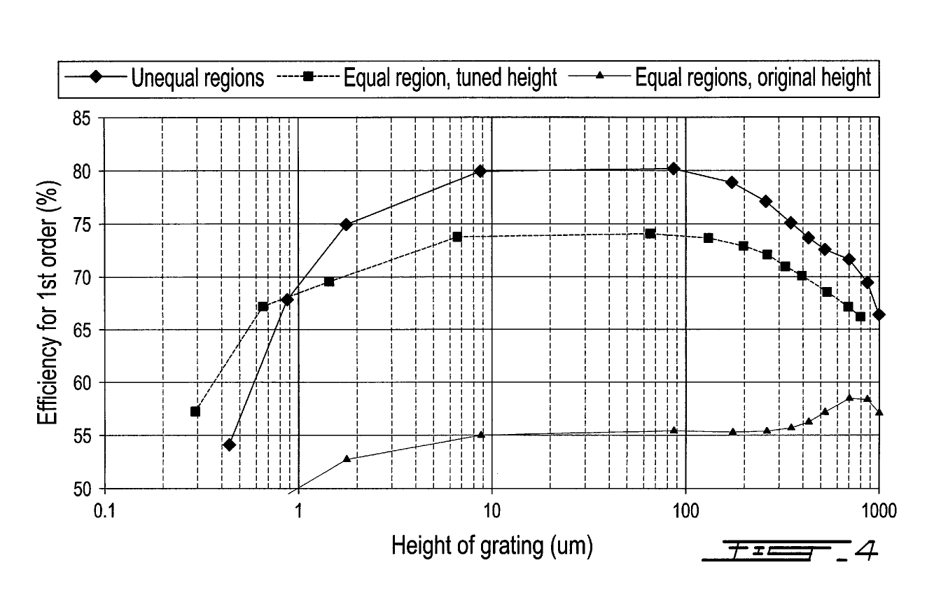

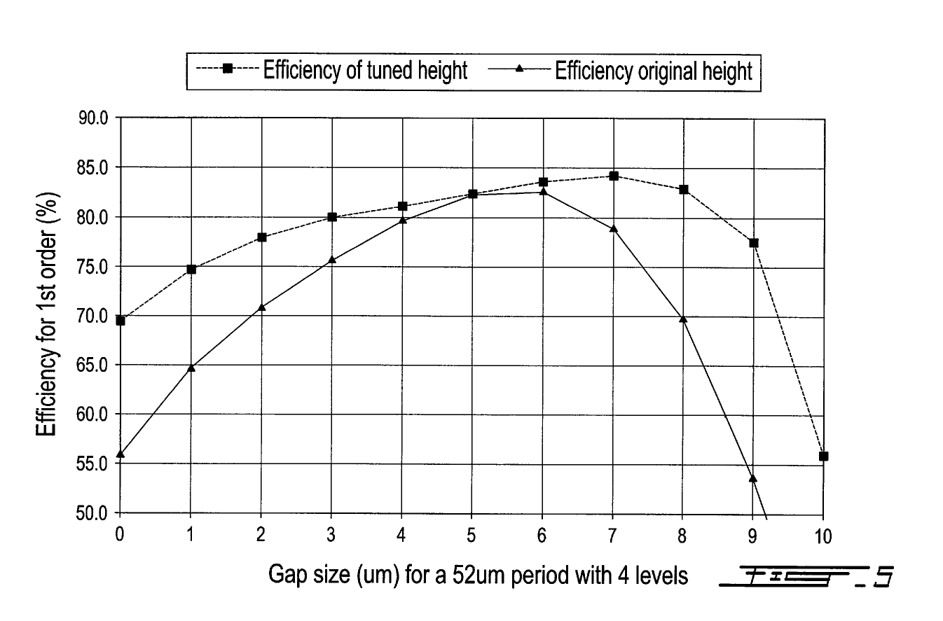

Referring now to FIGS. 3A and 3B, a transmission mode ROPA, generally referred to using the numeral 300 and in accordance with a third illustrative embodiment of the present invention, will now be described. The ROPA 300 is again comprised of an EO crystal 302 electrically coupled to a CMOS chip 304. As in ROPA 200, a 1D array of contact electrodes, as in 306, are illustratively deposited on the EO crystal 202 between a front face of the CMOS chip 304 and a back face of the EO crystal 302. An additional ground contact electrode 308, this time potentially opaque, is disposed on the front face of the crystal 302 and again adequately grounded such that a linear array of activation voltages may be applied between the electrodes 306 and 308 through the crystal 302. To activate such voltages and control the ROPA 300, the chip 304 may again be mounted to a circuit board or the like activated and controlled by a computer, a field programmable gate array (FPGA), or other such configurable electronic devices. A flip-chipping method is again recommended to mount the crystal 302 to the chip 304.

In ROPA 300, unlike in the reflection mode ROPAs 100 and 200, an optical beam C travels through the crystal 302 between the respective activation and ground electrodes 306 and 308; the beam is generally not reflected. Nonetheless, the spatially periodic application of activation voltages across the crystal may be used to control the direction of the beam C as it exits the crystal 302. Namely, in the absence of any voltages, or again in the presence of a constant voltage for each electrode 306, the beam C will travel through the crystal 302 unperturbed and exit to travel in a same direction as it was prior to entering the crystal 302. When, on the other hand, voltages are applied to the crystal to induce, for example, a 1D diffraction grating, the ROPA 300 may controllably alter the beams direction in an upward or downward fashion, namely based on the applied voltages' periodicity and induced index profile.

The ROPA 300 does provide certain advantages that should not be neglected. For instance, the ROPA 300 is constructed through a flip-chipping method, thereby allowing the control of a greater number of electrodes and consequently leading to lower optical losses in the system. Furthermore, using the CMOS chip, greater control and flexibility is provided in the control and activation of the ROPA 300.

When compared to the above transmission mode ROPAs 100 and 200, the ROPA 300 provides the benefit of using lower voltages to steer an input beam as this beam travels through the longer length of the crystal 302 as apposed to a smaller thickness thereof. A 2π phase shift, generally required to optimally redirect a beam through an induced diffraction grating, is easier to achieve using lower voltages as the beam spends more time within the crystal. Furthermore, the beam C travels between the electrodes 306 and 308 and need not traverse the ground electrode 308. As a result, the ground 308 can be opaque and material selection therefore is thus greatly increased. Ultimately, each ROPA 100, 200 and 300 may be used to redirect an input beam, the ROPA 100 potentially redirecting input beams in two dimensions.

Electrode Configuration and Size Selection

In order to adequately and controllably steer a beam using the above-described ROPAs, proper selection of the electrode configuration, electrode sizes and spacing must be addressed. For instance, the efficiency of the ROPA in steering a beam interacting therewith, that is the percentage of the light incident on the ROPA that will be redirected thereby, is dependent on the number of electrodes, their spacing and the voltage resolution available to their activation.

For example, it may be interesting to investigate the deflection angles and efficiencies that can be reasonably expected from the above ROPAs. To simplify the following, we assume the creation of a first order blazed grating, namely through the application of a 1D voltage pattern in the above ROPAs.

In Table 1 below, initial results are presented for gratings generated by a set of rectangular electrodes having a width of 10 μm. In these first results, it is assumed that no gaps separate the electrodes (a parameter considered further hereinbelow) and that the beam steered by the grating is normally incident thereon. Using scalar theory for light tuned at 1310 nm we obtain the following deflection angles and efficiencies for various grating periods d:

TABLE 1
Deflection Angles and Efficiencies for 10 μm Electrodes

| | # of levels in | | |
|---|---|---|---|
| d (in μm) | grating | Deflection angle | Efficiency η |
| 20 | 2 (binary) | ±3.76 | 40.5% |
| 30 | 3 | ±2.50 | 68.4% |
| 40 | 4 | ±1.88 | 81.1% |
| 50 | 5 | ±1.50 | 87.5% |
| 60 | 6 | ±1.25 | 91.2% |
| 70 | 7 | ±1.07 | 93.5% |
| 80 | 8 | ±0.94 | 95.0% |
| 90 | 9 | ±0.83 | 96.0% |
| 100 | 10 | ±0.75 | 96.8% |

Given these results, the 10 μm wide electrodes can be expected to provide reasonable deflection angles, for example, for coupling deflected beams into output fibres in the context of an optical switch in a telecommunication network. For instance, the creation of a 4-level grating using 10 μm wide electrodes could provide, based on this simplified calculation, sufficiently large deflection angles, namely ±1.88 degrees, with an efficiency of approximately 81%.

To further study the potential diffraction efficiency of the above-described ROPAs, grating efficiencies were compiled for various grating index profiles and thicknesses. To again simplify these calculations, certain parameters have been kept constant. Namely, all calculations have been performed for a 4-level transmission mode first order grating having a period of 52 μm, an input beam having an angle of incidence of zero degrees and a wavelength of 1310 nm and, a base substrate index of refraction n of 1.5.

In a first instance, the impact of the grating thickness (height), on grating efficiency was studied. For this study, two step profiles were considered: an uneven step profile defined by the default 1:2:2:1 step size ratio for a 4-level grating (step widths of 8.67 μm, 17.33 μm, 17.33 μm and 8.67 μm for the predefined 52 μm grating period), and an even step profile comprising steps of equal widths. Calculated efficiencies are first obtained for the uneven step profile, assuming no gaps between the steps, using an index of refraction change within the grating defined by Δn=λ/thickness, that is the optimized index change for this default profile. Accordingly, the index of refraction for each step were successively defined as n, n+Δn/3, n+2Δn/3 and n+Δn. Results for these calculations are provided in FIG. 4 and Table 2 below. As can be seen therein, efficiencies decrease for small and large thicknesses. The efficiency drop for thin gratings is explained by the fact that a larger Δn is required to satisfy the above relation for small thicknesses, thereby increasing the reflectivity of the grating and reducing the amount of light redirected by the grating. For larger grating thicknesses, shadowing effects become more important, thus explaining the decreased grating efficiencies for thicker gratings.

TABLE 2
Grating Efficiencies as a Function of Grating Height

| Grating with 1:2:2:1 | | | | | |
|---|---|---|---|---|---|
| step widths | | Grating with 1:1:1:1 step widths | | | |
| Height | Efficiency | Height | Efficiency | Tuned | Efficiency |
| (um) | (%) | (um) | (%) | height (um) | (%) |
| 0.4365 | 54.1 | 0.4365 | 43.5 | 0.299 | 57.2 |
| 0.873 | 67.8 | 0.873 | 49.5 | 0.661 | 67.2 |
| 1.746 | 75 | 1.746 | 52.8 | 1.437 | 69.6 |
| 8.73 | 79.9 | 8.73 | 55.1 | 6.75 | 73.8 |
| 87.3 | 80.2 | 87.3 | 55.5 | 67 | 74.1 |
| 174.6 | 78.9 | 174.6 | 55.4 | 133.9 | 73.6 |
| 261.9 | 77.1 | 261.9 | 55.5 | 199.8 | 72.9 |
| 349.2 | 75.2 | 349.2 | 55.8 | 268 | 72.0 |
| 436.5 | 73.7 | 436.5 | 56.3 | 334 | 71.0 |
| 523.8 | 72.7 | 523.8 | 57.1 | 403 | 70.1 |
| 698.4 | 71.7 | 698.4 | 58.5 | 547 | 68.5 |
| 873 | 69.6 | 873 | 58.4 | 698 | 67.2 |
| 999.585 | 66.5 | 999.585 | 57.2 | 802 | 66.1 |

Of greater interest herein is efficiency results calculated for the even step profile, such a profile being somewhat easier to implement in the above ROPAs than the uneven step profile using electrodes of constant width and spacing. Looking first at the efficiency results for an even step profile using the same thicknesses and index changes (Δn) as for the uneven step profile (triangle trace in FIG. 4), it is apparent that the even step profile is not as efficient as its uneven counterpart. Yet, by tuning the height of the grating for the selected index changes (Δn) to maximise the efficiency thereof, results similar to the results obtained for the uneven step profile may be obtained. Consequently, the efficiency of a 4-level grating defined by an even step profile can be optimized to compare to the efficiency of a similar grating defined by the uneven 4-level step profile. This result shows that the use of evenly shaped and spaced electrodes, as in 106, 206 and 306 in the above-described ROPAs, can provide adequate grating efficiencies that can be further optimised by varying the thickness of the grating, that is, the thickness of the crystals 102, 202 and 302.

Since gaps are required between the electrodes of the above-described ROPAs, calculations should also be performed to evaluate the theoretical efficiency variations induced by the incorporation of such gaps between the steps of a 4-level grating. Considering equal width electrodes, the index profile within a 4-level grating may be defined as comprising a region with an index of refraction n between each successive step of increasing index n, n +Δn/3, n+2Δn/3 and n+Δn. In these calculations, the width of each step is now defined as being the sum of the electrode width (illustratively 10 μm) and the gap width (illustratively 3 μm) such that the period of the grating is still 52 μm. For the following results, a crystal thickness of 523.8 μm, reasonable in the context of the above-described ROPAs, and a corresponding index change Δn=0.0025 were selected.

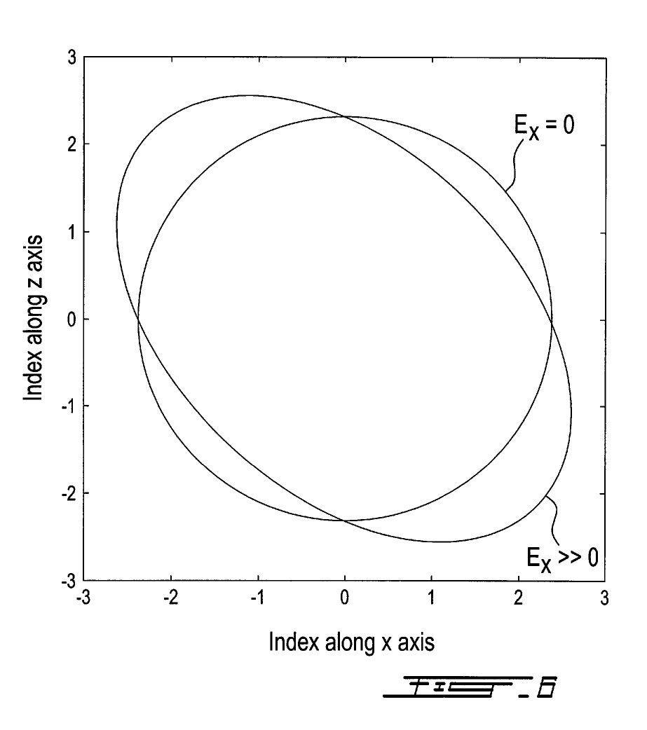

In FIG. 5, efficiencies are reported for various gap sizes (ranging from 1 μm to 10 μm for constant 13 μm step sizes) and for both a constant thickness of 523.8 μm and for a thickness tuned to optimize the efficiency for a given gap size. Again, results indicate that grating efficiencies can be optimized for a given configuration by adjusting the thickness of the grating. Furthermore, the results of FIG. 5 clearly show an increase in efficiency for increasing gap sizes below 6-7 μm. This unexpected result presents a beneficial effect as gaps between electrodes in the above-described ROPAs are inevitable.

However, careful electrode spacing selection can be considered to reduce the likelihood of voltage breakdowns between the electrodes. In the above-described ROPA configurations, presently designed to operate at voltages ranging from 0 to about 300V as described hereinbelow, electrode spacing of about 3 μm to 5 μm is deemed appropriate to avoid such effects, although in practice it has been revealed that maintenance of about a 2 μm gap size is sufficient to avoid voltage breakdowns between the electrodes. These gap sizes are also deemed to be reasonable in view of the above results on the effect of gaps on ROPA efficiencies. A person of skill in the art will understand that electrode spacing may be adjusted to optimize the operability of the ROPA, namely if voltages greater than 300V are used to activate the device, or again to maximize the resolution of the device for increased electrode numbers and the like. All such variations may be applied to the ROPA designs without departing form the general scope and nature of the present disclosure.

Electro-optic Crystal Selection

The choice of an electro-optic crystal for use in the above-described ROPAs is not straightforward. Certain parameters should be considered including: the magnitude of the electro-optic coefficient, the transparency of the crystal to infrared radiation, crystal loss (dB/cm), the crystal response time and the Curie temperature of the crystal. Additionally, the crystal is illustratively of uniform molecular polarization and uniformly poled along an axis substantially at right angles to the direction the light beam enters the crystal.

The first parameter, the electro-optic coefficient, defines what voltage will need to be applied to the crystal to induce the 2π phase shift in an optical beam travelling within the crystal required to redirect the beam efficiently and coherently. Namely, what voltage will be required to generate an index of refraction change sufficiently large to induce such a phase shift in the beam as the beam propagates within the crystal. A larger electro-optic coefficient will require a lower voltage, or again a shorter signal propagation length within the crystal.

As presented hereinabove, the CMOS chips 104, 204 and 304 used in the above-described illustrative embodiments may comprise a CMOS chip made from a high-voltage CMOS process capable of both low-voltage and high-voltage digital design. For example, CMOS chips as those fabricated using the DALSA Semiconductor C08G CMOS process have been tested to provide voltages ranging from 0 to 300V with a 4.7V resolution. Consequently, selection of suitable crystals for these ROPA designs can be at least partially guided by the general limitations of the CMOS chips, namely in the maximum voltage available therewith of about 300V. The ROPAs 100, 200 and 300 should be designed to operate below this maximum voltage, used herein as a guide for crystal selection, to generate a 2π phase shift in an input optical beam travelling through the ROPA and experiencing these voltages. A person of skill in the art will understand that crystal selection will depend on the activation means and devices available at the time of manufacture of the ROPAs. For instance, use of higher voltage CMOS chips, or other such programmable activation chips, may increase or decrease the selection of potential EO crystals suitable for the above-described ROPAs.

As for the transparency to infrared, a parameter of interest when dealing with optical communication networks, a good number of known electro-optic crystals satisfy this requirement.

The optical loss parameter, though generally important to reduce, for example, fibre-to-fibre losses in an optical network (losses within the ROPA as the optical signal is redirected or switched from one fibre or channel to another fibre of channel), it becomes less important in the reflection mode ROPAs 100 and 200 described hereinabove as the signal travels through the thickness of the ROPA's crystal, which is generally small, as opposed to travelling through a length of the crystal, as in the above transmission mode ROPA 300. This factor thus becomes more important for the design of ROPA 300.

The requirement for a very fast response time highlights the advantages of electro-optic materials over other technologies such as MEMs and liquid crystals. Electro-optic crystals in general have response times on the order of nanoseconds, and the final speed of the device will most likely be limited by the electronics and not by the response time of the material. Namely, electronic response times of about 8 μs have been reported for the above-described CMOS chips. Such response times, being well above EO crystal response times, will likely be the governing factor in determining the overall switching speed of the device.

The device should also operate below the Curie temperature of the electro-optic material. Therefore the material will either need to have a Curie temperature that is higher than the operating temperature, or the device will need to be cooled.

In the design of the reflection mode ROPAs 100 and 200, the electric field applied between the reflective electrodes 106, 206 and the ground electrode 108, 208 is in a direction substantially parallel to the direction of propagation of the incident beam (A, B); this means that the electric field of the incident beam will be substantially perpendicular to the applied electric field. Therefore, a crystal must be selected for which the electro-optic coefficient is such that the index change induced by the applied electric field is in a direction perpendicular thereto.

Consider the following electro-optic tensor of electro-optic coefficients:

$${r}_{ij} = ( \begin{matrix}{r}_{11} & {r}_{12} & {r}_{13} \\ {r}_{21} & {r}_{22} & {r}_{23} \\ {r}_{31} & {r}_{32} & {r}_{33} \\ {r}_{41} & {r}_{42} & {r}_{43} \\ {r}_{51} & {r}_{52} & {r}_{53} \\ {r}_{61} & {r}_{62} & {r}_{64}\end{matrix} )$$

When multiplied by an applied electric field, the following result is obtained:

$$[ \begin{matrix}{Δ ( \frac{1}{{n}^{2}} )}_{1} \\ {Δ ( \frac{1}{{n}^{2}} )}_{2} \\ {Δ ( \frac{1}{{n}^{2}} )}_{3} \\ {Δ ( \frac{1}{{n}^{2}} )}_{4} \\ {Δ ( \frac{1}{{n}^{2}} )}_{5} \\ {Δ ( \frac{1}{{n}^{2}} )}_{6}\end{matrix} ] = [ \begin{matrix}{r}_{11} & {r}_{12} & {r}_{13} \\ {r}_{21} & {r}_{22} & {r}_{23} \\ {r}_{31} & {r}_{32} & {r}_{33} \\ {r}_{41} & {r}_{42} & {r}_{43} \\ {r}_{51} & {r}_{52} & {r}_{53} \\ {r}_{61} & {r}_{62} & {r}_{64}\end{matrix} ] [ \begin{matrix}{E}_{x} \\ {E}_{y} \\ {E}_{z}\end{matrix} ]$$

These changes in refractive indices can then be used to calculate the index ellipsoid defined as follows:

$${( \frac{1}{{n}^{2}} )}_{1} {x}^{2} + {( \frac{1}{{n}^{2}} )}_{2} {y}^{2} + {( \frac{1}{{n}^{2}} )}_{3} {z}^{2} + 2 {( \frac{1}{{n}^{2}} )}_{4} yz + 2 {( \frac{1}{{n}^{2}} )}_{5} xz + 2 {( \frac{1}{{n}^{2}} )}_{6} xy = 1$$

Therefore, the electro-optic coefficients rᵢⱼ for which i=j (diagonal coefficients) do not contribute towards creating an index change in a direction perpendicular to the applied electric field. The diagonal coefficients only create an index change in the same direction as the applied electric field. Yet, any of the off-diagonal coefficients will generate an index change in the desired perpendicular direction. Consequently, crystals having relatively large off-diagonal coefficients will generally be suitable for use in the reflection mode ROPA designs presented hereinabove.

One example of a crystal suitable for the reflective mode ROPAs 100 and 200 is a BaTiO₃ crystal defined by the following electro-optic tensor (where the units of the coefficients are in pm/V):

$${r}_{ij} = ( \begin{matrix}0 & 0 & 12 \\ 0 & 0 & 12 \\ 0 & 0 & 112 \\ 0 & 1920 & 0 \\ 1920 & 0 & 0 \\ 0 & 0 & 0\end{matrix} )$$

This material is tetragonal with a 4 mm form. In the absence of an applied electric field, the x and y axes both have an index of refraction nₒ=2.37 (at 800 nm) and the z axis has an index of refraction of nₑ=2.32 (again at 800 nm).

If the crystal is oriented such that the electric field is applied therein along the x-axis, the resultant index ellipsoid is defined by:

$$\frac{{x}^{2}}{{n}_{o}^{2}} + \frac{{y}^{2}}{{n}_{o}^{2}} + \frac{{z}^{2}}{{n}_{e}^{2}} + 2 {r}_{51} {E}_{x} xz = 1$$

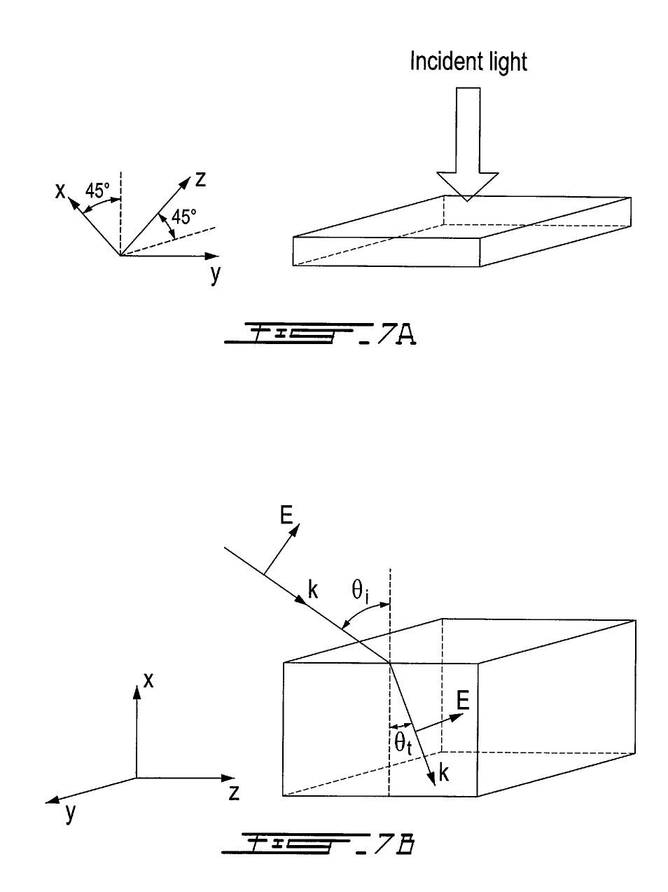

Since in this example, there is no index change along the y-axis for a non-zero electric field, one can consider only the refraction indices in the xz plane. In FIG. 6, the projection of the index ellipsoid in the xz plane is plotted for Eₓ=0 and Eₓ>1. From the plots of FIG. 6, one determines that in order to fully benefit from the large r₅₁ coefficient of BaTiO₃ when an electric field is applied in the x direction, the incident beam should be directed along the x=z direction and polarized in the x=−z direction. This means that an incident beam angle within the crystal of 45 degrees would maximize the desired effect.

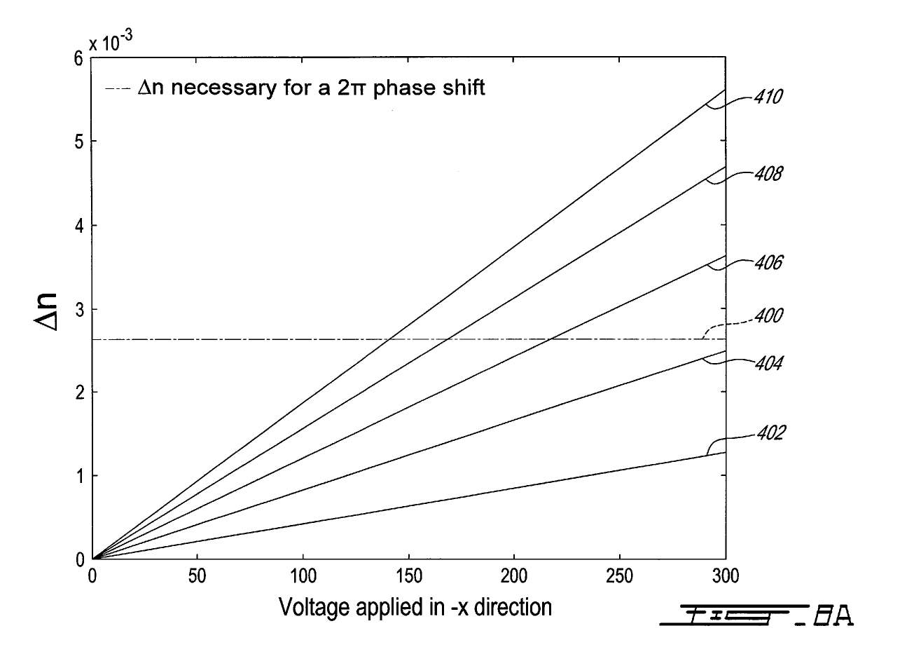

Consequently, there are two ways to maximize the effect in this crystal: either the crystal should be cut along a 45 degree axis such that light incident normal to a top face of the crystal is already directed along the x=z axis (FIG. 7A), or the light incident on a regularly cut crystal should be angled to propogate within the crystal to maximize the desired effect (FIG. 7B). In this latter configuration, the angle of incidence θᵢ of the input beam will be limited by the critical angle of the crystal, estimated at about 25 degrees. However, as discussed hereinbelow, the off-diagonal electro-optic coefficient of BaTiO₃ is sufficiently large that, for a given voltage below 300V, there is still a sufficient index change generated for small angles θᵢ to obtain the desired 2π phase shift.

A person of skill in the art will now understand that other crystals and crystal configurations may also be considered to provide a like effect without departing from the general scope and nature of the present disclosure. For instance, crystal and applied electric field geometries may be altered to benefit from other coefficients, such as for example the r₄₂ coefficient of BaTiO₃ exploitable much like the r₅₁ coefficient using crystal symmetry arguments. Other such crystals defined by other off-diagonal coefficients may also be considered. Appropriate crystal, electric field and beam input geometries can be studied for each new crystal based on the position of the strong off-diagonal coefficient in the electro-optic tensor of the crystal. Namely, a crystal exhibiting a strong r₁₃ coefficient would benefit from an applied electric field along the z-axis and a beam incident along the z-axis and polarized in x. Such configurations and geometries should now be apparent to a person of skill in the art.

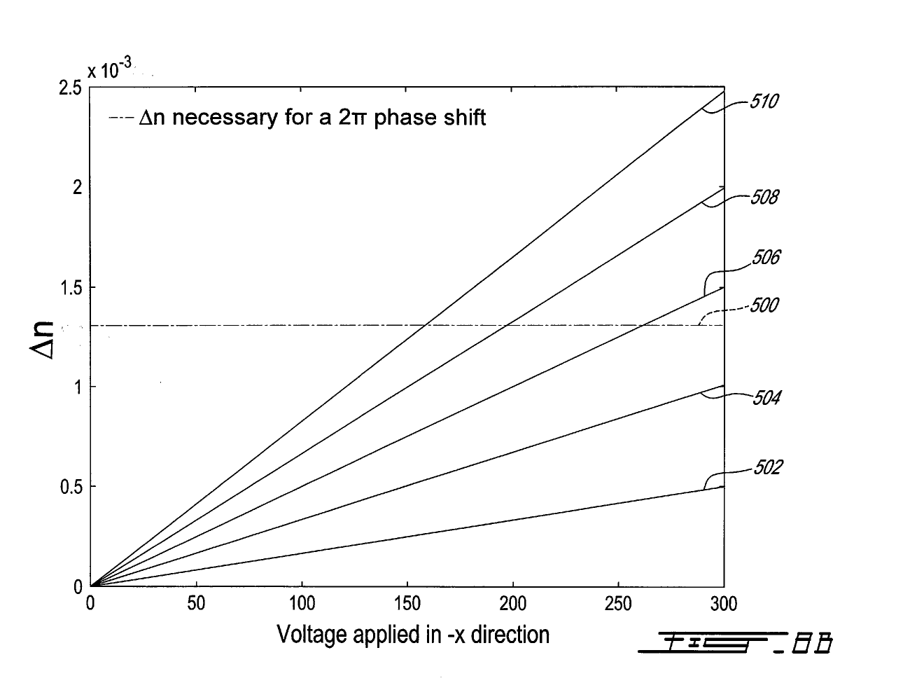

Referring now to FIG. 8A, results obtained for the crystal/beam geometry of FIG. 7B are presented. In this graph, index changes are calculated as a function of applied voltage for a BaTiO₃ crystal of 500 μm thickness operating in transmission mode for a beam tuned at 1310 nm (that is, passing only through the thickness of the crystal without reflection). The dash-dot horizontal line (400) represents the index change required to induce a 2π phase shift in the beam as it travels through the thickness of the crystal. Plots 402, 404, 406, 408 and 410 represent calculations for an input beam incident on the top face of the crystal at an angle θᵢ of 5 degrees (402), 10 degrees (404), 15 degrees (406), 20 degrees (408) and 25 degrees (410) respectively. Clearly, a 10 degree incidence angle θᵢ will suffice to operate a BaTiO₃-based device below about 300V. Note that, although the present transmission mode embodiment is described hereinabove with reference to a beam propagating through the thickness of the crystal, a person of skill in the art will now understand that a similar transmission mode could be used though the length of the crystal.

Referring now to FIG. 8B, similar results are obtained, but this time, for a device operated in reflection mode, as described hereinabove with reference to FIGS. 1A and 2A and the illustrative embodiments of ROPAs 100 and 200. In this scenario, since the input beam will travel through the thickness of the crystal twice, a smaller index change, illustrated by the dash-dot line 500, is required to produce a same effect. In FIG. 8B, plots 502, 504, 506, 508 and 510 represent calculations for an input beam incident on the top face of the crystal, as in FIG. 7B, at an angle of 2 degrees (502), 4 degrees (504), 6 degrees (506), 8 degrees (508) and 10 degrees (510) respectively. As can be seen from these results, an incidence angle θᵢ of about 5 degrees will suffice to operate the reflection mode BaTiO₃-based device below about 300V.

These results thus clearly indicate that the off-diagonal coefficients of BaTiO₃ are sufficiently large to consider BaTiO₃ as a suitable crystal for the implementation of ROPAs 100 and 200, as described hereinabove in accordance with the first and second illustrative embodiment of the present invention.

In the design of the transmission mode ROPA 300, the electric field applied between the reflective electrodes 306 and the ground electrode 308 across the device is in a direction substantially perpendicular to the direction of propagation of the incident beam C. This means that the electric field of the incident beam may be substantially parallel to the applied electric field by proper selection of the beam's polarization. Therefore, the crystal selection becomes much simpler for this construction, the generally stronger r₁₁, r₂₂ and r₃₃ crystal coefficients becoming the most significant coefficients herein. Furthermore, since the input beam C propagates through a length of the crystal 302 instead of a thickness thereof, smaller voltages are required to obtain a 2π phase shift in the propagating beam C.

To find a crystal suitable for the design of ROPA 300, one considers the voltage V_{2π} required to obtain the desired 2π phase shift for a given crystal thickness d and crystal length L. If a linear electro-optic crystal is used (Pockels effect), the required voltage is given by:

$${V}_{2 π} = \frac{2 λ d}{{n}_{e}^{3} {r}_{33} L}$$

If a quadratic electro-optic crystal is used (Kerr effect), the required voltage is given by:

$${V}_{2 π} = d \sqrt{\frac{2 λ}{{n}^{3} sL}}$$

Table 3 below lists some common electro-optic crystals and their parameters, these parameters used in the above equations for V_{2π} in Table 4 below.

TABLE 3
Common Electro-Optic Materials and their Parameters

| | | | | | | Curie | |
|---|---|---|---|---|---|---|---|
| | | | r₁₃ | r₃₃ | | Temp | Transparency |
| EO Material | nₒ | nₑ | (pm/V) | (pm/V) | s (m²/V²) | (° C.) | (nm) |
| PLZT (8.5/65/35) | | ≈2.5 | NA | NA | 38.60 × 10⁻⁶ | | |
| PLZT (9/65/35) | | ≈2.5 | NA | NA | 3.80 × 10⁻⁶ | 70 | |
| LiNbO₃ | 2.29 | 2.2 | 10 | 32.6 | NA | 606 | 400-5000 |
| LiTaO₃ | 2.18 | 2.18 | 8 | 33 | NA | 606 | 400-5000 |
| SBN: 60 | 2.31 | 2.30 | 37 | 237 | NA | 75 | 370-6000 |
| SBN: 75 | 2.30 | 3.32 | 67 | 1340 | NA | 56 | 350-6000 |
| Polymer (Pacific | | ≈1.5 | | 90 | NA | NA | |
| Wave) | | | | | | | |

TABLE 4
Voltages Required for a 2π Phase Shift for Given Crystal Dimensions

| | 1-D configuration (2 cm long) | | |
|---|---|---|---|
| | Thickness | Volts (V) | Volts (V) |
| EO materials | (μm) | 850 nm | 1310 nm |
| PLZT (8.5/65/35) | 400 | 15 | 19 |
| PLZT (9/65/35) | 400 | 48 | 59 |
| LiNbO₃ | 400 | 102 | 151 |
| LiTaO₃ | 400 | 101 | 153 |
| SBN: 60 | 400 | 11 | 18 |
| SBN: 75 | 400 | 2 | 3 |

Though all of the above-listed crystals may be used in the design of ROPA 300 with applied voltages well below 300V, SBN stands out as requiring relatively low voltages to induce the desired 2π phase shift due to its very high electro-optic coefficient. Yet, SNB is a photo-refractive material often used to make holograms and for other non-linear effects such as four-wave mixing. However, its absorptive range is below infrared wavelengths and since the intensity of the input beam C is generally very low (≈1 mW) compared to the intensities used in non-linear optics, the electro-optic effect should dominate over the photo-refractive effect.

A person of skill in the art will understand that any of the above-listed crystals, as well as many other EO crystals not listed here but exhibiting similar EO properties, may also be used in the design of ROPA 300. Though lower activation voltages may be beneficial in some contexts, any crystal operable with activation voltages below about 300 V should be sufficiently efficient to produce the desired effect in most applications.

Optical Switch

The above described ROPA designs may be used to create a switch that is useful for an all-photonic network that it is very fast, exhibits low loss, is tuneable to a wide range of wavelengths and can be adapted to interact with a reasonably high number of output ports. To better exemplify the use of these devices as such, reference is now made to FIGS. 9A and 9B, in accordance with a fourth illustrative embodiment of the present invention, illustrating the use of the ROPA 200 of FIG. 2A as an optical switch 700. As described hereinabove, a beam D is incident on the front face of a crystal 702, in this illustrative embodiment a poled BaTiO₃ crystal, oriented such that a CMOS chip 704, through electrodes 706 and 708 and the application of various voltages ranging between 0 and 300V thereon, generates a linear periodic array of applied electric fields along an x-axis of the crystal 702 thereby generating an organised diffractive optical element therein. In this illustrative embodiment, the CMOS chip provides an array of 64 reflective metal electrodes for activation of the switch 700, the electrodes being 20 μm wide and separated by 5 μm to prevent arching. Also, the crystal dimensions are roughly 5mm×5 mm×0.5 mm and the beam D is tuned at about 1310 nm. In order to minimize the reflection of the beam D on a front face of the crystal 702, the incoming TM polarized beam D is at an angle of incidence that is close to the Brewster angle of the crystal 702.

As can be seen in the illustrative embodiment of FIG. 9B, the light incident on the switch 700 can be redirected in one of three directions for a given set of induced grating parameters defined by a oth order diffraction and a ±1 order diffraction. Of particular interest here are the ±1 order diffractions, as simulated hereinabove to calculate various diffraction efficiencies for various ROPA electrode configurations.

Using the above parameters, efficiencies of the ±1 order diffractions as a function of the number of electrodes within a single grating period are presented in FIG. 10. From these results, we observe simulated diffraction efficiencies ranging between 40 and 60% for gratings consisting of 3 to 8 electrodes per grating period. As the number of electrodes increases, the ability to tailor the profile of the grating increases, leading to greater diffraction efficiencies. However, an increasing period leads to a reduction in the deflection angle. For instance, when working at 1310 nm and with between 3 and 8 electrodes per period, the deflection angles of the ±1 order diffracted beams range from 1.0 degrees to 0.38 degrees respectively.

The number of output ports for a ROPA-based optical switch, as in 700, is dependent on the divergence of the impingent light and the spatial separation between outputs. Using the above results, a 1×6 switch could be realized by tuning the electrode voltages for either the +1 or the −1 order and for a generated grating of 3, 5 or 8 electrodes per period. This would adequately and controllably redirect the impingent beam in any one of 6 directions defined by deflection angles ranging between 1 and −1 degrees from the 0^{th} order deflection.

A person of skill in the art will understand that greater port counts may be provided with different electrode and voltage configurations. Namely, by altering the electrode widths, spacing and number, by altering the crystal thickness or orientation, or again by providing a different range of voltages through the CMOS chip to name a few, different gratings and deflection angles may be obtained. Furthermore, by implementing the 2D ROPA design of FIGS. 1A and 1B, a 2D switch may be developed to redirect an input beam into a 2D array of output ports. Such modified configurations should now be apparent to a person of skill in the art and are not meant to extend the general scope and nature of the present disclosure.

Also, as discussed hereinabove, the ROPA designs 100, 200 and 300 may also be used in various other applications including, but not limited to, variable focus length lenses, multiple spot generation, corrections to free-space misalignments, beam shaping and the like. For instance, various index profiles may be generated within the crystals of ROPAs 100, 200 and 300 to manipulate and control an optical beam incident thereon. Various periodic and aperiodic profiles may be preprogrammed and/or customised to provide various optical effects. Using ROPA 100, 2D profiles may also be generated, increasing the general number of potential uses and applications of this design.

Although the present invention has been described hereinabove by way of specific embodiments thereof, it can be modified, without departing from the spirit and nature of the subject invention as defined in the appended claims.

What is claimed is:

1. An optical device comprising:
an electro-optic crystal comprising a first surface and a second surface opposite said first surface;
a plurality of first regions between said first surface and said second surface; and
a means for applying a voltage across each of said regions, each of said applied voltages inducing a change in the refractive index of a respective one of said regions;
wherein a light beam entering said crystal along a first path exits said crystal along a second path at an angle to said first path.

2. The device of claim 1, wherein said first surface is substantially parallel to said second surface.

3. The device of claim 2, wherein said first surface and said second surface are separated by a distance of about 500 microns.

4. The device of claim 1, wherein said first regions are separated by a at least one second region and further wherein no voltage is applied across said second region.

5. The device of claim 1, wherein said crystal is of uniform molecular polarisation.

6. The device of claim 4, wherein each of said first regions is about 20 microns thick and further wherein adjacent first regions are separated by at least about 2 microns.

7. The device of claim 1, wherein said first regions are like regions of rectangular cross section and arranged in parallel.

8. The device of claim 1, wherein said first regions are like regions of square cross section and arranged in a matrix.

9. The device of claim 1, wherein said voltage applying means comprises a first electrode adjacent said first surface, a second electrode adjacent said second surface and a voltage source connected between said first electrode and said second electrode.

10. The device of claim 9, wherein said voltage source is a high voltage CMOS circuit having a controllable output voltage of between 0V and 300V.

11. The device of claim 10, wherein said controllable output voltage has a resolution of 4.7V.

12. The device of claim 10, wherein a plurality of said high voltage CMOS circuits are provided in an integrated package, a plurality of said second electrodes are arranged along said second surface and further wherein each of said high voltage CMOS circuits is interconnected with a respective one of said second electrodes using a flip chip bonding technique.

13. The device of claim 12, wherein said integrated package further comprises a programmable controller for independently controlling a voltage of each of said high voltage CMOS devices.

14. The device of claim 9, wherein said first electrode is a substantially transparent ITO electrode, said second electrode comprises a reflective surface adjacent said second surface and further wherein the light beam enters said crystal via said first surface, is reflected by said reflective surface and exits said crystal via said first surface.

15. The device of claim 14, wherein said crystal is uniformly poled along an axis parallel to said second surface.

16. The device of claim 7, wherein said crystal further comprises a third surface substantially at right angles to said second surface and parallel to said first regions and a fourth surface opposite said third surface and wherein the light beam enters said crystal via said third surface and exits said crystal via said forth surface.

17. The device of claim 16, wherein said crystal is uniformly poled along an axis normal to said second surface.

18. A method for defracting a beam of light travelling along a path, the method comprising the steps of:
providing an electro-optic crystal comprising a first surface and a second surface opposite said first surface;
defining a plurality of regions between said first surface and said second surface along the path; and
applying a voltage across each of said regions, each of said applied voltages inducing a change in the refractive index of a respective one of said defined regions.

19. The method of claim 18, wherein a voltage applied to one of said regions is different from a voltage applied to an adjacent region.

20. The method of claim 18, further comprising the step of combining said regions into adjacent groups of N regions and further wherein within a given group said applied voltage increases linearly from a first region to an Nth region between a maximum voltage divided by N and said maximum voltage.

21. The method of claim 20, wherein said maximum voltage is 300V.

22. The method of claim 20, wherein N is between 3 and 8.

23. The method of claim 22, wherein N=4 and further wherein a voltage across a first region is about 75V, a second region is about 150V, a third region is about 225V and a forth region is about 300V.

24. An electro-optic crystal for use as an active medium in an optical switch, the optical switch adapted to reflectively redirect an optical beam incident thereon from a first reflected direction to at least one second reflected direction when a spatially periodic voltage gradient is applied between opposing faces of the crystal, a maximum voltage applied to the crystal to generate the voltage gradient being below about 300V, the crystal being defined by an electro-optic tensor comprising at least one coefficient sufficiently large to induce at least a 2π phase shift in an optical beam travelling through the crystal in a region thereof where the maximum voltage is applied.

25. The electro-optic crystal as claimed in claim 1, wherein said coefficient is selected from the group consisting of the a r₅₁ coefficient, a r₄₂ coefficient and a r₃₃ coefficient.
